(19) United States
(12) Patent Application Publication
(10) Pub. No.: US 2007/0028218 A1
(43) Pub. Date: Feb. 1, 2007

(54) Apparatus, system, and method for a software test coverage analyzer using embedded hardware

(76) Inventors: Joel Leslie Masser, San Jose, CA (US); Helen Maria Witter, Morgan Hill, CA (US)

Correspondence Address: KUNZLER & ASSOCIATES, 8 EAST BROADWAY, SUITE 600, SALT LAKE CITY, UT, 84111, US

(21) Appl. No.: 11/194,244

(22) Filed: Aug. 1, 2005

(51) Int. Cl. G06F 9/44

(52) U.S. Cl. 717/124

(57) ABSTRACT

An apparatus, system, and method are disclosed for a software test coverage analyzer using embedded hardware, An assignment module is included to assign one or more ranges of code within a routine of computer code. An instruction identification module is included to store an identifier for each instruction executed in the routine, where embedded hardware identifies each executed instruction. A determination module is included to determine a range that contains the executed instruction. A counter module counts each executed instruction within an assigned range.

### BACKGROUND OF THE INVENTION

1. Field of the Invention

This invention relates to test coverage analyzers and more particularly relates to a test coverage analyzer using embedded hardware.

2. Description of the Related Art

While computers are becoming very sophisticated, they lack a human's ability to focus on what is intended rather than literal input. For this reason, even minor mistakes by a programmer in writing computer code can cause problems when the computer executes the programmer's code. Computers literally interpret every line of code that is executed. The consequences of mistakes in the code or “bugs” can be disastrous. For example, bugs in computer code can cause the computer to run slowly, can cause errors in computations, and can cause computers to “crash” or, in other words, to stop executing commands. Bugs in computer code in critical applications such as banking operations, communications, or “911” emergency services may cause great financial loss or may even endanger lives.

Computer programs are becoming increasingly complex and may involve millions of lines of code. A change in one section of code may seem correct, but may have unintended consequences in other sections. A seemingly minor change may cause catastrophic errors. Detecting and correcting errors in computer code is extremely important to prevent errors and crashes of computer code. Programmers strive to detect programming bugs through thorough testing of software prior to releasing it to users. However, even extensive testing may not be adequate since today's programs are large and many sections of the code may not be exercised by the testing.

Programmers have attempted to detect if sections of code are not being executed during testing through various means such as test coverage analyzers. One common method is to periodically read the contents of critical registers which may reveal the address of an instruction that is being executed. This method has the advantage that the source code does not have to be modified for the testing or the test coverage analysis. From the address information, the instruction being executed is determined. This method has some serious drawbacks. If every address of every instruction that is executed during a test is captured, the amount of data generated is enormous and difficult to review. To avoid this dilemma, sampling is employed. A typical sampling rate may be one in every thousand. Such sampling has the major drawback that, although testing may be extensive, some sections may be missed and the sampling rate may not catch whether a particular section of code was executed or not. Because sampling intentionally fails to check for every instruction, a programmer cannot be sure that a recent bug fix has been properly exercised or tested.

Other similar methods may include external hardware that monitors registers or address and data buses. These methods may be advantageous over other similar methods without external hardware in that they may not require as many resources of the computer on which the code is executed and may run quicker. However, these external hardware methods still have the drawbacks of choosing sampling rates which may miss critical data, or choosing to detect every executed instruction or a high sampling rate which may generate too much data.

Another method for determining test analyzer coverage is to cause an interrupt in the computer when a specified section or line of code is executed. While this method may be used to reveal every time a section or line of code is executed, this method may cause extremely slow computer operation or may reduce the integrity of the computer code being tested. For example, a programmer may change a section of code without any errors and may put an interrupt request in the modified code. The interrupt request may include an error which may which may cause problems with the execution of the code. Even if the interrupt request was carefully placed without an error, the programmer may cause an error when removing the extraneous interrupt request and the error may cause other computing problems for a customer. The danger of improperly modifying the source code may outweigh any benefits derived though adding interrupts or other instructions for the purpose of testing.

From the foregoing discussion, it should be apparent that a need exists for an apparatus, system, and method that provide test analyzer coverage using embedded hardware. Beneficially, such an apparatus, system, and method would use embedded hardware to accurately determine if computer code instructions are executed without modifying the source code for determining testing coverage.

### SUMMARY OF THE INVENTION

The present invention has been developed in response to the present state of the art, and in particular, in response to the problems and needs in the art that have not yet been fully solved by currently available software test coverage analyzers. Accordingly, the present invention has been developed to provide an apparatus, system, and method for a software test coverage analyzer using embedded hardware that overcome many or all of the above-discussed shortcomings in the art.

The apparatus for a software test coverage analyzer using embedded hardware is provided with a logic unit containing a plurality of modules configured to functionally execute the necessary steps of selecting ranges of code in a routine, storing an identifier during execution for each executed instruction in the routine using embedded hardware, and determining a range for which each executed instruction in the routine belongs. These modules in the described embodiments include an assignment module configured to assign one or more ranges of code within a routine of computer code. The apparatus includes an instruction identification module that stores an identifier for each instruction executed in the routine during program execution, where embedded hardware identifies each executed instruction. The apparatus includes a determination module that determines an assigned range that contains the executed instruction.

In one embodiment, the apparatus includes a counter module that counts each executed instruction within an assigned range. The apparatus, in another embodiment, is a configured to include a selection module to select the routine, wherein the routine comprises computer code within a program. In one embodiment, the routine comprises the program. In yet another embodiment, the instruction identification module stores an identifier for each instruction executed in the routine in real time. In another embodiment, the program is free from modifications to allow identification of each instruction executed in the routine.

The assignment module, in one embodiment, includes an instruction range module that assigns one or more instructions as a range. In another embodiment, the instruction range module assigns one or more instructions as a range by identifying the location of the one or more instructions as an offset address from an address of a subroutine. In yet another embodiment, the instruction range module assigns one or more instructions as a range by identifying the location of the one or more instructions as an offset address from an address of a control section (“CSECT”). In one embodiment, a range comprises a CSECT. In another embodiment, a range comprises a subroutine.

In one embodiment, the apparatus includes a display module that displays the one or more ranges and the number of times an instruction was executed in each range. In yet another embodiment, the assignment module identifies an address for the one or more CSECTs or subroutines.

A system of the present invention is also presented for a software test coverage analyzer using embedded hardware. The system may be embodied by a mainframe computer with a processor and a memory. The system may include a data storage device, and a terminal connected through an input/output device. The equipment may be connected to a communication bus. In particular, the memory, in one embodiment, includes a selection module that selects a routine, where the routine comprises computer code within a program. The memory includes an assignment module that assigns one or more ranges of code to sections of the routine of computer code. The memory includes an instruction identification module that stores an identifier for each instruction executed in the routine during execution of the program, where embedded hardware in the processor identifies each executed instruction. The memory includes a determination module that determines an assigned range that contains the executed instruction and a counter module that counts each time an instruction is executed within a range. In one embodiment, the mainframe computer supports a z/OS® operating system.

A method of the present invention is also presented for a software test coverage coverage analyzer using embedded hardware. The method in the disclosed embodiments substantially includes the steps necessary to carry out the functions presented above with respect to the operation of the described apparatus and system. In one embodiment, the method includes selecting a routine of computer code within a program and assigning one or more ranges of code within the routine. The method also includes storing an identifier for each instruction executed in the routine while testing the computer code, where embedded hardware identifies each executed instruction and determining an assigned range that contains the executed instruction. In one embodiment, selecting a routine of computer code within a program includes selecting more than one routine.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for a software test coverage analyzer using embedded hardware in accordance with the present invention;

FIG. 2 is a schematic block diagram illustrating one embodiment of an apparatus for a software test coverage analyzer using embedded hardware in accordance with the present invention;

FIG. 3 is a schematic block diagram illustrating another embodiment of an apparatus for a software test coverage analyzer using embedded hardware in accordance with the present invention;

FIG. 4 is a schematic flow chart diagram illustrating one embodiment of a method for a software test coverage analyzer using embedded hardware in accordance with the present invention;

FIG. 5A is a schematic flow chart diagram illustrating part of another embodiment of a method for a software test coverage analyzer using embedded hardware in accordance with the present invention; and

FIG. 5B is a schematic flow chart diagram illustrating part of another embodiment of a method for a software test coverage analyzer using embedded hardware in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. A module may be a combination of hardware and software.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

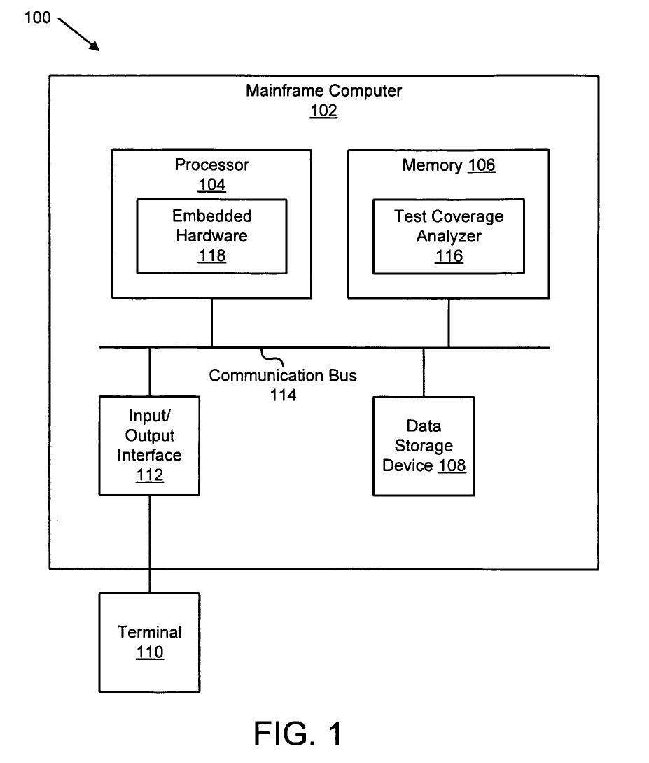

FIG. 1 is a schematic block diagram illustrating one embodiment of a system 100 for a software test coverage analyzer with embedded hardware in accordance with the present invention. The system 100 comprises a mainframe computer 102 with one or more processors 104, a memory 106, a data storage device 108, and a terminal 110 accessed through an input/output interface 112—all of which are connected through a communication bus 114. The terminal 110 may be a dedicated terminal, a personal computer, a laptop computer, or the like. The data storage device 108 may be integral to the mainframe computer 102, may be a device in a storage area network, may be a tape drive, a magnetic hard drive, an optical storage device, or may be a library storage system.

The memory 106 includes a software test coverage analyzer 116. In one embodiment, the test coverage analyzer 116 uses data from embedded hardware 118 in the processor 104 to identify an instruction being executed if the instruction is part of a specified routine, and to determine if the executed instruction is within any of the specified ranges. In another embodiment, the embedded hardware 118 may be external to the processor 104.

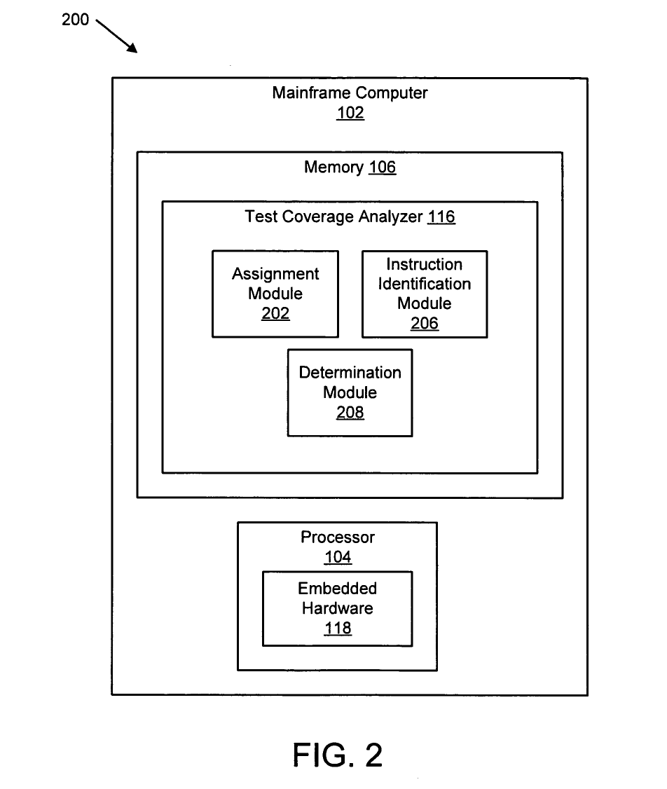

FIG. 2 is a schematic block diagram illustrating one embodiment of an apparatus 200 for a software test coverage analyzer using embedded hardware in accordance with the present invention. The apparatus 200 includes test coverage analyzer 116 in a memory 106 as well as one or more processors 104 with embedded hardware 118 on a mainframe computer 102. The test coverage analyzer 116 includes an assignment module 202 configured to assign one or more ranges to sections of a routine of computer code. The routine may also be called a module and represents a section of computer code within a computer program or computer application. The computer code may be source code or object code. The routine may be of interest while testing the program because the routine may have been recently modified, may be suspected of having an error, may not have been tested, or the like. The routine of interest may be a module or may be a larger segment or may comprise the entire program.

The assignment module 202 may identify ranges of computer code within the routine. In one embodiment, a range includes a control section or “CSECT.” In another embodiment, a range includes a subroutine. In yet another embodiment, a range includes a routine. In another embodiment, a range may include code in more than one CSECT or subroutine. Typically, CSECTs may be identified from object code created by compiling the program or routine. Subroutines and the like may be identified through information available from a compiler listing of the compiled version of the program or routine. For example, such listing information and object code are available for programs or routines compatible with the z/OS® operating system. A range may also include an instruction. A range may also be instructions distributed in a program and grouped into a range.

In one example, the assignment module 202 comprises a Restructured Extended Executor (“REXX”) executable program called RANGES. REXX is a structured, procedural script programming language and may be used on z/OS® machines as well as other platforms. The RANGES software allows a user to identify and select ranges of computer code within a routine. RANGES is a program from IBM.

The assignment module 202, in one embodiment, identifies a relative address for CSECTs, subroutines, or the like. The relative address may be used to identify CSECT or subroutine spacing, length, etc. In one embodiment, the identified relative address corresponds to a physical address in the data storage device 108. In another embodiment, the identified relative address corresponds to an address in the memory 106. In yet another embodiment, the assignment module 202 identifies a relative address that corresponds to an address in the data storage device 108 and the relative address corresponds to a new address in memory 106 when the program or routine is transferred to memory 106 for testing or execution.

For example, a routine may be located in a data storage device 108 at address 1,000 and may go to address 100,000. RANGES may return the names and addresses of the CSECTs in the routine. A user may select three CSECTs as ranges: A from 1,000 to 10,000, B from 10,001 to 20,000, and C from 20,001 to 30,000. If the user wants more detail from CSECT B, the RANGES program may return names and addresses for subroutines in CSECT B and the user may select two subroutines as ranges: B1 from 21,000 to 23,000 and subroutine B2 from 23,001 to 25,000. If the user wants more detail in subroutine B1, the user may select individual instructions or groups of instructions as ranges. For example, the user may select a range comprising an instruction at 21,040 by selecting subroutine B1 with an offset of 40. In another embodiment, a range comprising instructions may be selected as a specific address rather than an address of a subroutine with an offset. In another embodiment, the assignment module 202 and the instruction range module 308 may select ranges from a routine or program in memory 106. One skilled in the art will recognize other ways to assign portions of code in a ways to assign portions of code in a routine or program as ranges of code to be evaluated using a test coverage analyzer with embedded hardware.

The test coverage analyzer 116 includes an instruction identification module 206 configured to store an identifier for each instruction executed in the routine during execution of the program, where embedded hardware 118 identifies each executed instruction. The identifier may comprise the contents of the registers when the instruction is executed. In another embodiment, the identifier includes register information for more than one executed instruction. In another embodiment, the identifier includes contents of counters or accumulators. In yet another embodiment, an identifier includes an instruction address. An identifier in another embodiment includes a relative address of an executed instruction while in another embodiment an identifier includes an actual address of an executed instruction. One of skill in the art will recognize other relevant information stored when an instruction is executed to allow identification of an executed instruction.

In one embodiment, the instruction identification module 206 stores the identifier for the executed instruction in a buffer in memory 106 and then transfers contents of the buffer to the data storage device 108 when the buffer is full. In another embodiment, the instruction identification module 206 stores the identifier in memory 106. In another embodiment, the instruction identification module 206 stores the identifier in the data storage device 108. In one embodiment, the instruction identification module 206 stores the identifier of the executed instruction only if the executed instruction is in the routine.

In one embodiment, the instruction identification module 206 stores the identifier in real time. In another embodiment, the instruction identification module 206 does not store the identifier in real time and stores identification of the executed instruction in memory 106 or on the data storage device 108. In one embodiment, the embedded hardware 118 providing information to the instruction identification module 206 is Program Event Recording tracing or PER tracing. PER tracing is typically available on Z/OS® compatible machines. In another embodiment, the instruction identification module 206 incorporates incorporates Generalized Trace Facility (“GTF”) software integrated with the embedded hardware 118 to facilitate collection and storage of the identifier if the instruction is in the routine. GTF software is available on z/OS® machines. While PER tracing and GTF on a z/OS® compatible machine may be included in one embodiment, the present invention includes any embedded hardware 118 and associated software capable of identifying whether an instruction is executed. The embedded hardware 118 is advantageous because it allows testing of software without modifying the source or object code and it allows testing to identify each time an instruction or an instruction in a range of code is executed.

Program execution relevant to the test coverage analyzer 116 is typically done when the program is tested. Testing typically includes an extensive battery of tests or scenarios but may comprise tests of any length. In one embodiment, testing is directed at the routine of the computer program. In another embodiment, testing is directed at the program in general. In another embodiment, testing is directed at a CSECT. In yet another embodiment, testing is directed at a subroutine. One skilled in the art will recognize other testing for software test analysis where a test coverage analyzer 116 would be useful.

The test coverage analyzer 116 includes a determination module 208 configured to determine an assigned range that contains the executed instruction. The determination module evaluates the identified executed instruction from the instruction identification module 206 and then determines if the identified executed instruction falls within a range defined by the assignment module 202. In one embodiment, the determination module 208 comprises a PTHFNDR1 program from IBM. In another embodiment, the instruction identification module 204 stores one or more identifiers on the data storage device 108 and the determination module 208 uses the identifiers on the data storage device 108 to determine if an identified instruction falls within a range defined by the assignment module 202. In a further embodiment, the instruction identification module 204 is on one mainframe computer 102 and the determination module 208 is on another computer or mainframe computer 102. This embodiment would allow a user to generate identifiers and then analyze the identifiers to determine the relevant then analyze the identifiers to determine the relevant ranges at a later time. In addition, the stored identifiers can be re-used after analysis and sub-ranges can be defined and analyzed.

Beneficially, the test coverage analyzer 116 allows execution or testing of a routine or program free from modifications to the source or object code of the program being tested. In this way a program can be executed or tested and information gathered as to which instructions, subroutines, or CSECTs were executed without any code modifications of the tested program. A programmer may make modifications to a routine to fix a bug, add a feature, or the like and then test that routine without further modifications associated with the testing or test coverage analysis. In another embodiment, the program or routine can be modified to add display information, add interrupts, etc. to gain additional information beyond the information provided by the test coverage analyzer 116.

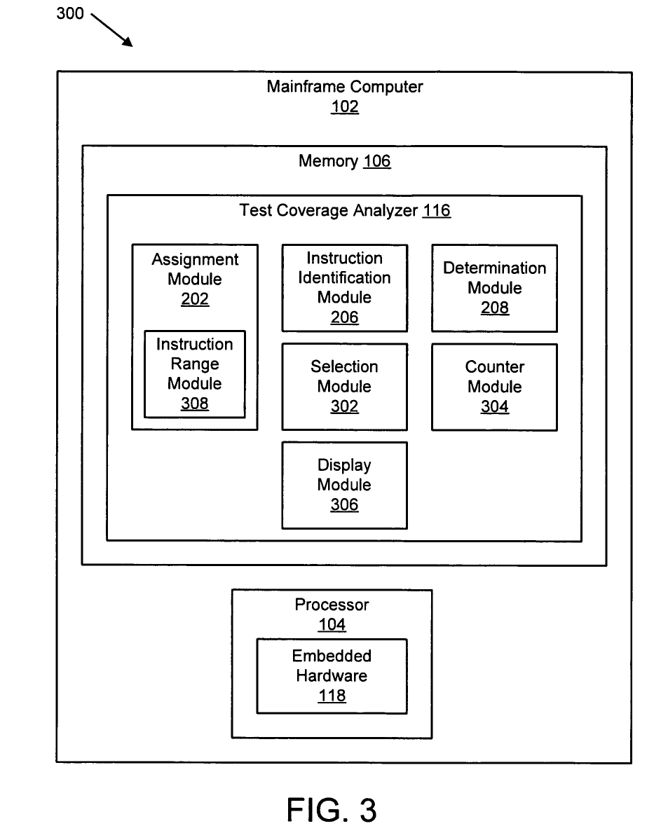

FIG. 3 is a schematic block diagram illustrating one embodiment of an apparatus 300 for a software test coverage analyzer 116 using embedded hardware 118 in accordance with the present invention. The test coverage analyzer 116 is in memory 106 in a mainframe computer 102 and includes an assignment module 202, an instruction assignment module 206, and a determination module 208 substantially the same as described for the test coverage analyzer 116 in FIG. 2.

The test coverage analyzer 116 includes a selection module 302 configured to select the routine, where the routine comprises source or object code within a program. In one embodiment, the selection module 302 selects a routine that is a part of a program. In another embodiment, the selection module 302 selects the entire program as the routine. In yet another embodiment, the selection module 302 selects more than one routine.

The test coverage analyzer 116 includes a counter module 304 configured to count each executed instruction within a range. Once the determination module 208 determines that a range contains an executed instruction, the counter module 304 may increase a counter associated with the range. In one embodiment, each range assigned by the assignment module has a counter. In a particular embodiment, the counter module 304 comprises a PTHFNDRA comprises a PTHFNDRA program from IBM.

The test coverage analyzer 116 includes a display module 306 configured to display the ranges assigned by the assignment module 202 along with the number of times an instruction was executed within each range. In one embodiment, the display module 306 displays information associated with the identifier for the executed instruction. In another embodiment, the display module 306 displays this information on the terminal 110. In another embodiment, the display module 306 provides a file with the ranges and number of times an instruction was executed in each range. In yet another embodiment, the display module 306 provides a file with the display information and also displays the information on the terminal 110. In one embodiment, the display module 306 allows a user to configure the information provided by the display module 306. In a particular embodiment, the display module 306 comprises the PTHFNDRA program. One skilled in the art will recognize other ways for the display module to display the assigned ranges and number of times instructions were executed in each range.

The assignment module 202 includes an instruction range module 308 configured to assign an instruction as a range. In another embodiment, the instruction range module 308 assigns a group of instructions to a range. Typically, a group assigned to a range by the instruction range module 308 contains a number of instructions less than the number of instructions in the subroutine that contains the group of instructions. In one embodiment, the instruction range module 308 determines an instruction location for defining the range as an address offset from the address of the start of the subroutine, CSECT, or other position in the routine. In another embodiment, the instruction range module 308 allows a user to manually select one or more instructions to be assigned as a range. One skilled in the art will recognize other ways for the instruction range module 308 to assign a range to one or more instructions in a routine.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

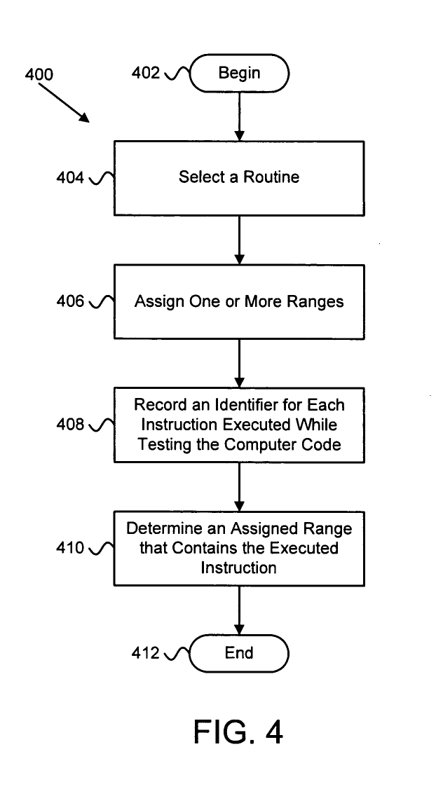

FIG. 4 is a schematic flow chart diagram illustrating one embodiment of a method 400 for a software test coverage analyzer using embedded hardware in accordance with the present invention. The method 400 begins 402 and the selection module 302 selects 404 a routine of computer code within a program. The assignment module 202 then assigns 406 one or more ranges within the routine. The instruction assignment module 206 then stores 408 an identifier for each instruction executed during program execution during testing. The computer code that is executed may be a program, part of a program, or a routine. The determination module 208 then determines 410 an assigned range that contains the executed instruction and the method 400 ends 412.

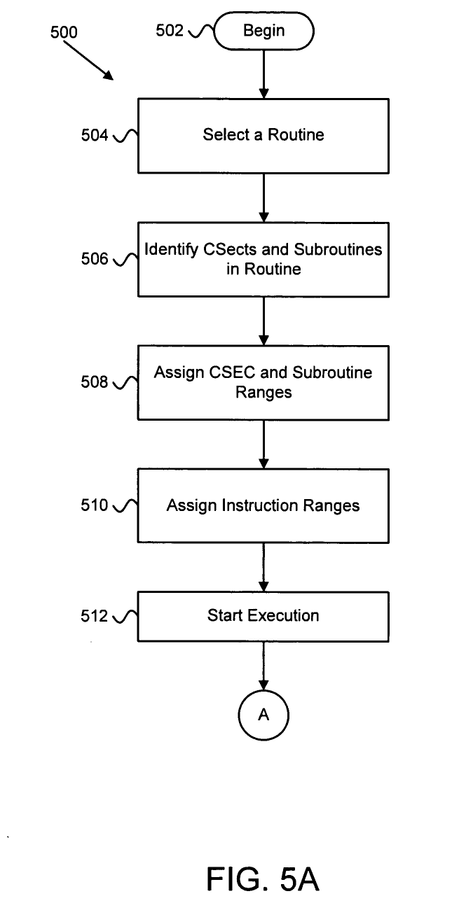

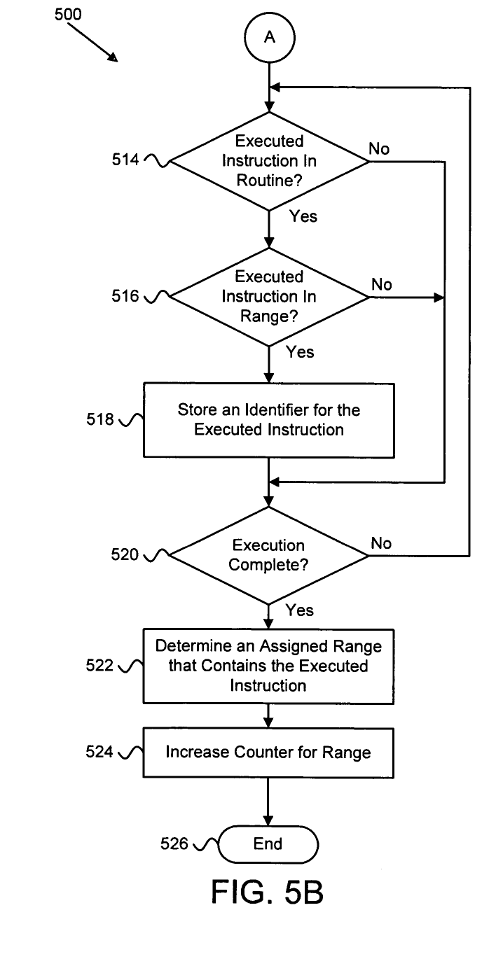

FIG. 5, encompassing FIGS. 5A and 5B, is a schematic flow chart diagram illustrating another embodiment of a method 500 for a software test coverage analyzer using embedded hardware in accordance with the present invention. The method 500 begins 502 (see FIG. 5A) and the selection module 302 selects 504 a routine of computer code within a program. The assignment module 202 then identifies 506 locations of CSECTs and subroutines subroutines in the routine. The assignment module 202 then assigns 508 CSECTs and subroutines as ranges. For example, a user may select a subroutine if a CSECT containing the subroutine does not provide enough desired detail in a test coverage analysis. The instruction range module 308 then assigns 510 instruction ranges. For example, if a subroutine does not provide enough detail, a user may assign 510 through the instruction range module 308 individual instructions or groups of instructions as ranges. In one embodiment, the RANGES program may be used for selection of CSECTs, subroutines, or instruction ranges.

The program executes 512 during testing of the software or other program execution. The instruction assignment module 206 then determines 514 if an executed instruction is in the routine during program execution. (Follow FIG. 5A letter A to FIG. 5B.) If the instruction assignment module 206 determines 514 the executed instruction is in the routine, the instruction assignment module 206 then determines 516 if the executed instruction is in a range. If the instruction assignment module 206 determines 516 the executed instruction is in a range, the instruction assignment module 206 stores 518 an identifier for the executed instruction. If the instruction assignment module determines 514 the executed instruction is not in the routine or determines 516 the executed instruction is not in a range, the instruction assignment module 206 does not store 518 an identifier for the executed instruction. In one embodiment the PER tracing embedded hardware 118, the GTF program, and the PTHFNDR1 program cooperate to determine 514 if an executed instruction is in a routine, determine 516 if an executed instruction is in a range, and store an identifier for the instruction.

The instruction identification module 206 then determines 520 if the execution of the program is complete. If the instruction identification module 206 determines 520 that the execution is not complete, the method 500 returns and the instruction assignment module 206 then determines 514 if the next executed instruction is in the routine. If the instruction identification module 206 determines 520 that the execution is complete, the determination the determination module 208 determines 522 an assigned range that contains the executed instruction. The counter module 304 then increases 524 a counter for the range containing the executed instruction and the method 500 ends 526. In one embodiment, the PTHFNDRA program determines 522 an assigned range that contains the executed instruction and increases 524 a counter for the range. In another embodiment, the instruction assignment module 206 stores an identifier for each instruction executed in the routine and the determination module 208 determines which executed instructions are within a range after the execution or testing is complete. One of skill in the art will recognize other methods to select a routine, select ranges in a routine, use embedded hardware 118 to store an identifier for each executed instruction in a routine, and determine a range that contains an executed instruction.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to test computer code using embedded hardware, the apparatus comprising:
an assignment module configured to assign one or more ranges of code within a routine of computer code;
an instruction identification module configured to store an identifier for each instruction executed in the routine during program execution, wherein embedded hardware identifies each executed instruction; and
a determination module configured to determine an assigned range that contains the executed instruction.

2. The apparatus of claim 1, further comprising a counter module configured to count each executed instruction within an assigned range.

3. The apparatus of claim 1, further comprising a selection module configured to select the routine, wherein the routine comprises computer code within a program.

4. The apparatus of claim 3, wherein the routine comprises the program.

5. The apparatus of claim 1, wherein the instruction identification module stores an identifier for each instruction executed in the routine in real time.

6. The apparatus of claim 1, wherein the program is free from modifications to allow identification of each instruction executed in the routine.

7. The apparatus of claim 1, wherein the assignment module further comprises an instruction range module configured to assign one or more instructions as a range.

8. The apparatus of claim 7, wherein the instruction range module assigns one or more instructions as a range by identifying the location of the one or more instructions as an offset address from an address of a subroutine.

9. The apparatus of claim 7, wherein the instruction range module assigns one or more instructions as a range by identifying the location of the one or more instructions as an offset address from an address of a control section (“CSECT”).

10. The apparatus of claim 1, wherein a range comprises a CSECT.

11. The apparatus of claim 1, wherein a range comprises a subroutine.

12. The apparatus of claim 1, further comprising a display module configured to display the one or more ranges and the number of times an instruction was executed in each range.

13. The apparatus of claim 1, wherein the assignment module identifies an address for one or more CSECTs or subroutines.

14. A system for a test coverage analyzer using embedded hardware, the system comprising:
a processor in a mainframe computer;
a computer memory in the mainframe computer, the memory comprising
a selection module configured to select a routine, wherein the routine comprises computer code within a program;
an assignment module configured to assign one or more ranges of code within the routine of computer code;
a instruction identification module configured to store an identifier for each instruction executed in the routine during execution of the program, wherein embedded hardware in the processor identifies each executed instruction;
a determination module configured to determine an assigned range that contains the executed instruction; and
a counter module configured to count each time an instruction is executed within a range.

15. The system of claim 14, wherein the instruction identification module stores an identifier for each instruction executed in the routine in real time.

16. The system of claim 14, wherein the mainframe computer supports a z/OS® operating system.

17. A signal bearing medium tangibly embodying a program of machine-readable instructions executable by a digital processing apparatus to perform an operation to test computer code using embedded hardware, the operation comprising:
an operation to select a routine of computer code within a program;
an operation to assign one or more ranges of code within the routine;
an operation to store an identifier for one or more instructions executed in the routine during program execution, wherein embedded hardware identifies each executed instruction; and
an operation to determine an assigned range that contains the executed instruction.

18. The signal bearing medium of claim 17, wherein the instructions further comprise an operation to count each executed instruction within an assigned range.

19. The signal bearing medium of claim 17, wherein an operation to select a routine of computer code within a program further comprises an operation to select more than one routine.

20. The signal bearing medium of claim 17, further comprising an operation to display the one or more ranges and the number of times an instruction was executed in each range.
